(19) United States
(12) Patent Application Publication
(10) Pub. No.: US 2017/0297486 A1
(43) Pub. Date: Oct. 19, 2017

(54) NOISE SIMULATOR

(71) Applicant: RENE MAGANA, FREEDOM, CA (US)

(72) Inventor: RENE MAGANA, FREEDOM, CA (US)

(21) Appl. No.: 15/130,933

(22) Filed: Apr. 16, 2016

(51) Int. Cl. B60Q 5/00; H04R 29/00

(52) U.S. Cl. CPC B60Q 5/008; H04R 29/00; H04R 2499/13; H04R 2430/01

(57) ABSTRACT

The present invention relates to noise simulator providing guide any vehicle noise two-fold benefit; safety to bring awareness to the presence of the vehicle, accident avoidance and novelty, by being able to project the noise of a variety of motors to produce a soothing sound for both the user and to the listener.

### FIELD OF THE INVENTION

The present invention relates to a noise simulator to guide any vehicle noise.

### BACKGROUND OF THE INVENTION

Usually, road traffic safety refers to methods and measures for reducing the risk of a person using the road network for being killed or seriously injured. The users of a road include pedestrians, cyclists, motorists, their passengers, and passengers of on-road public transport, mainly buses and trams.

In addition to this, best-practice road safety strategies focus upon the prevention of serious injury and death crashes in spite of human fallibility which is contrasted with the old road safety paradigm of simply reducing crashes assuming road user compliance with traffic regulations. Safe road design is now about providing a road environment which ensures vehicle speeds within the human tolerances for serious injury and death wherever conflict points exist.

Moreover, a lot of people worry when they are walking alone on a quiet urban street, but imagine how much greater the fear would be if you were blind. A growing number are turning to self-defense to help boost their confidence, many blind and visually impaired people rely on their dogs to get around, but what happens if the assistance animal is attacked? But with or without a dog, a blind person is more vulnerable to attack. Also, a hybrid vehicle that the visually impaired may not sense if it is too close to a cross walks, because the car is so quiet.

Therefore, there remains a need to overcome above mentioned problems and our invention resolve this entire problem.

### SUMMARY OF THE INVENTION

The main objective of the present invention is to overcome the limitations of the prior arts by providing noise simulator with many benefit such as: safety to bring awareness to the presence of vehicle, accident avoidance and novelty, by being able to project the noise of a variety of motors to provide a soothing sound output from the vehicle.

In order to achieve the above mentioned objective, the present invention provides an, the scope of the idea applies to bicycles, motorcycles and scooter wherein the safety feature being equally if not more important for this types of conveyance

Moreover, the present invention of the noise simulator which is installed in the user's vehicle driving any motor, engine, battery or electrically operated vehicle is able to sense any vehicle, person, animal or any related things on road or on the cross walk and is able produce simulated noise which enables simulation of overall noise of the vehicle driven by the user which is further amplified and modified to produce a soothing sound for the vehicle driver and also for the person, animal or any related thing on the road which also add up to the entertainment value to vehicle and do not produce irritating noise while driving and standing on road or on a cross walk.

Also in the present invention of a noise simulator the vehicle used for the installation of the noise simulator is enabled in any vehicle which is not battery or electrically or engine operated.

### BRIEF DESCRIPTION OF THE DRAWINGS

FIG. 1 illustrates the schematic view of the given invention according to an embodiment of the invention.

### DETAIL DESCRIPTION OF THE DRAWINGS

Reference will now be made in detail to the exemplary embodiment (s) of the invention, examples of which are illustrated in the accompanying drawings. Whenever possible, the same reference numerals will be used throughout the drawings to refer to the same or like parts.

The present invention relates to a noise simulator [100] guide having many benefit so as to bring safety awareness to the presence of the vehicle, accident avoidance and novelty, by being able to project the noise of a variety of motors to produce a soothing sound for both the user and to the listener.

The noise simulator is installed in any vehicle(s) and does not limit its scope to only four wheeler vehicle(s) or battery or electrically operated vehicle(s). The present invention installation on any vehicle(s) is compatible for bicycle(s), motorcycle(s) and scooter(s) but the scope is not limited to only these and the safety feature being equally if not more important for this types of conveyance.

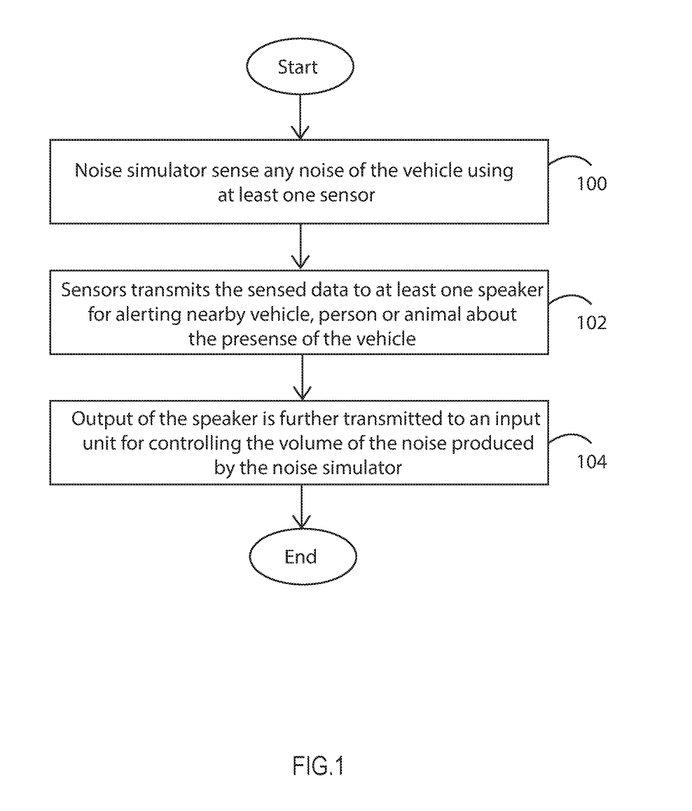

FIG. 1 illustrates the systematic working of the noise stimulator comprising different steps:

Step.100 of illustrates sensing the input noise via any vehicle(s) which make use of at least one sensor to do the same. First sensor(s) is used to detect vehicle speed wherein, the noise would be simulated based on rate of speed and acceleration or deceleration is to be accomplished with mechanical instrument, such as speedometer, radar, laser, etc. The second sensor(s) is used to detect throttle input; other possible control mechanism is a sensor that relays throttle input to the system controlling pitch and volume of the vehicle noise.

Step.102 illustrates transmitting the sensors input to the speaker(s). In the present invention of noise simulator the external speaker enables simulating vehicle noise wherein the external speaker is installed with other components in system which is to be placed in the trunk or under the hood anywhere outside the cab of the vehicle to make noise more audible to those outside the car. The internal speaker wherein the internal speaker simulates the noise inside the cabin for automobiles and trucks so the user experiences the desired simulated noise as well, wherein speaker for any two wheeler(s) or any vehicle without engine or without being battery operated is also included in the frame.

Step 104 illustrates further transmit the output from the speaker(s) to the input unit wherein the input unit enables a wired or wireless access at steering wheel/handle bar, control center to change pitch and volume of engine noise, or remote button, phone app, radio remote of the output sound produced and finally the noise is give out and in to produce the desired impact for which the noise simulator is been designed.

In the preferred embodiment the present invention of the noise simulator which is installed in the user's vehicle driving any motor, engine, battery or electrically operated vehicle is able to sense any vehicle, person, animal or any related things on road or on the cross walk and is able produce simulated noise which enables simulation of overall noise of the vehicle driven by the user which is further amplified and modified to produce a soothing sound for the vehicle driver and also for the person, animal or any related thing on the road.

In another embodiment of the present invention of a noise simulator the vehicle used for the installation of the noise simulator is any vehicle which need not to be a battery or electrically or engine operated vehicle. This noise simulator is installed anywhere on the vehicle simulating the voice of the voice produced while paddling wherein the present invention of noise simulator is much more beneficial for the visually impaired person who cannot sense the vehicle noise when it is too close to the cross walk.

While the invention has been described in detail with specific reference to preferred embodiments thereof, it is understood that variations and modifications thereof may be made without departing from the true spirit and scope of the invention.

1. A noise simulator coupled to any part of a vehicle comprising:
a—a plurality of sensors, wherein the plurality of sensors enables sensing the noise produced by the vehicle;
b—a speaker, coupled to the plurality of the sensors, wherein the speaker enables modification and amplification of the overall noise produced by the vehicle; and
c—an input unit enabled to receive an output from the speaker and further enables a wireless access to at least one of a steering wheel, a handle bar, a control center or the combination thereof to change a pitch and a volume of the overall noise produced by the vehicle.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The noise simulator in claim 1, wherein the noise simulator is enabled to be installed to any of the vehicle, wherein the vehicle need not to be a battery, an electrically or an engine operated vehicle.

22. The noise simulator in claim 1, wherein the noise simulator enabled to get installed on the non-electrical, non-battery type or engine less vehicle simulates the voice produced while paddling and further produce a soothing voice.

23. The noise simulator in claim 1, wherein the noise simulator also enables a wireless access to at least one of the steering wheel, the handle bar, the control center or the combination thereof to change the pitch and the volume of the overall noise produced by the vehicle.

24. The noise simulator in claim 1, wherein the wireless access to the at least one of the steering wheel, the handle bar, the control center or the combination thereof is enabled to be given via phone app, radio remote or any combination thereof
